(19) United States
(12) Patent Application Publication
(10) Pub. No.: US 2026/0138289 A1
(43) Pub. Date: May 21, 2026

(54) Irreversible Passive Gripping Apparatus and Method

(71) Applicants: China National Nuclear Corporation Sichuan Environmental Protection Engineering Co., Ltd., Guangyuan (CN); Nusim S.A.U., Sevilla (ES); NEPTU International Co., Ltd., Shanghai (CN)

(72) Inventors: Yu CHANG, Guangyuan (CN); Hao FAN, Guangyuan (CN); Francisco Bernal Martínez, Guangyuan (CN); Wei WANG, Guangyuan (CN); Jingqian LIU, Guangyuan (CN); Xiangbao ZENG, Guangyuan (CN); Tianxin AN, Guangyuan (CN); Xiangjun ZU, Guangyuan (CN); Miguel Angel Bautista García, Guangyuan (CN); José Antonio Cuberos Castaño, Guangyuan (CN); Álvaro Jesús Cuadrado Álvaro, Guangyuan (CN); Ya ZHOU, Guangyuan (CN); Yun HE, Guangyuan (CN); Zhou ZHOU, Guangyuan (CN); Shuaizhen WU, Guangyuan (CN); Kunlin MU, Guangyuan (CN); Hexin SUN, Guangyuan (CN)

(21) Appl. No.: 19/006,847

(22) Filed: Dec. 31, 2024

(30) Foreign Application Priority Data
Nov. 20, 2024 (CN) 2024116603252

(51) Int. Cl. B25J 15/02

(52) U.S. Cl. CPC B25J 15/02

(57) ABSTRACT

The present invention discloses an irreversible passive gripping apparatus and method. The apparatus includes: a fixed assembly, an accommodating space, a sliding assembly, a connecting rod assembly, and a clamping assembly. When the sliding assembly slides toward the clamping assembly, the clamping assembly rotates out of the interior of the accommodating space to form a clamping angle. The present invention realizes stable passive gripping and automatic locking without power input, ensures safe and reliable operation, and adapts to the tolerances of different bucket edges.

### CROSS-REFERENCE TO RELATED APPLICATIONS

The present application claims priority to Chinese Patent Application No. 2024116603252, filed on Nov. 20, 2024, the entire disclosure of which is incorporated herein by reference.

### TECHNICAL FIELD

The present invention relates to the technical field of the nuclear industry, and in particular to an irreversible passive gripping apparatus and method.

### BACKGROUND

NUSIM has been developing equipment for safe lifting and transportation of radioactive packages since 1980. Based on operational experience, and after discovery of a lack of innovation in package lifting and treatment in the nuclear industry, NUSIM has developed a tool ecosystem for treating various types of packages and corresponding accessories in typical low-to-medium active radioactive waste storage facilities.

In these storage facilities, various sizes of buckets and containers are needed to be handled, and may be nested in other buckets or containers, or in larger containers. It is necessary to open and close the containers, stack the packages together, and execute a program of filling gaps or eventually sealing the packages. All of these operations require a variety of tools, which are suspended on an automated crown block, and it requires remote operations in a control room. Replacing a complicated robot tool that integrates a plurality of connections is time-consuming, risky and slow. In addition, each of these replacements in a radioactive environment exposes an operator to radiation for a long time.

A most basic and main storage unit is a cylindrical bucket. This means that most basic and main treatment equipment in the waste storage facility is a bucket treatment clamper, which, in our case, is a fixedly installed NUSPIDER clamper. It is usually suspended on a crown block covering processing, storage and/or shipping areas.

Innovation of NUSIM development is to use multi-tool concept application as a basis for development of treating and processing tool ecosystems. These tools use the NUSPIDER clamper as a general coupling system. Such fixed equipment can quickly and automatically install accessories with minimal operator's intervention, allowing development of new operations, otherwise these operations are incompatible with the NUSPIDER tools.

Therefore, in addition to treating the buckets, it is also possible to treat the containers, close the buckets or the containers, place stabilizing plates between various layers of the stacked packages, and even execute sealing with concrete or gap filling with gravel without replacing a main matrix tool of the crown block in an operated radioactive waste storage facility.

### SUMMARY

An objective of the present part is to outline some aspects of the embodiments of the present invention and to briefly describe some preferred embodiments. Some simplifications or omissions may be made in the present part as well as the abstract of the specification and the title of invention of the present application, so as not to obscure the objective of the present part as well as the abstract of the specification and the title of invention; however, such simplifications or omissions cannot be used for limiting the scope of the present invention.

In view of the above or existing problems in the prior art, the present invention is provided.

Therefore, an objective of the present invention is to provide an irreversible passive gripping apparatus, capable of maintaining grip force and suspension force without any power supply. It can grip a bucket without any action or power input, can release the bucket only needing to actively issue an instruction, can prevent the bucket from falling off accidentally in mid-air or due to improper support, can shorten a gripping time, can firmly clamp a sealed bucket and an opened bucket, and can safely grasp the bucket regardless of a weight of the bucket. There are 3 or 4 fixed points on the bucket, which provides an internal redundancy. A failure of one fixed point will not cause the bucket to fall off, and the bucket is still fixed by the remaining fixed points.

In order to solve the above technical problems, the present invention provides the following technical solution: an irreversible passive gripping apparatus includes a fixed assembly, provided with an accommodating space inside;
a sliding assembly, slidably arranged inside the fixed assembly;
a connecting rod assembly, having one end rotatably connected to the sliding assembly; and
a clamping assembly, having one end rotatably connected to the fixed assembly, where one end, close to the clamping assembly, of the connecting rod assembly is rotatably connected to the clamping assembly.

When the sliding assembly slides toward the clamping assembly, the clamping assembly rotates out of the interior of the accommodating space to form a clamping angle; and
there are at least two groups of symmetric irreversible passive gripping apparatuses, and the clamping assembly cannot be folded and make a release in carrying a gripped object due to a geometric shape of the clamping assembly.

As a preferred solution of the irreversible passive gripping apparatus of the present invention, the irreversible passive gripping apparatus further includes a transmission assembly.

The transmission assembly includes a rod connecting shaft connected to a side wall of the sliding assembly, and a wedge connecting rod connected to one end, close to the clamping assembly, of the connecting rod assembly;
the fixed assembly includes a housing;
the sliding assembly includes a fork rod, and the fork rod is slidably arranged inside the housing;
the connecting rod assembly includes a wedge rotating rod, and two ends of the wedge rotating rod are rotatably connected to the rod connecting shaft and the wedge connecting rod respectively; and
the clamping assembly includes a wedge, a wedge rotating shaft connected to one end of the wedge, and a rotating shaft connected to a middle part of the wedge rotating shaft.

As a preferred solution of the irreversible passive gripping apparatus of the present invention, the wedge is automatically folded by driving force from an edge of the gripped object during gripping to achieve passive gripping, and the wedge carries a weight of the gripped object through a mechanical interference structure, independent of a transmission system; and
the wedge cannot be folded and make a release in carrying the gripped object due to a geometric shape of the wedge.

As a preferred solution of the irreversible passive gripping apparatus of the present invention, the wedge includes a wedged body, used for forming a mechanical interference fit to an edge of the gripped object; and
a geometric structure of the wedged body is designed for snapping under a curl of an edge of the gripped object or onto a bottom of a sealing ring.

As a preferred solution of the irreversible passive gripping apparatus of the present invention, the irreversible passive gripping apparatus further includes a control assembly and a sensing assembly, where the control assembly includes an electromagnetic transmission rod, and the electromagnetic transmission rod is only used for folding and releasing actions of the wedge without participating in gripping and load carrying; and
release force of electromagnetic transmission rod is calibrated to prevent a release apparatus from starting in a case of an incomplete release of a load.

As a preferred solution of the irreversible passive gripping apparatus of the present invention, the sensing assembly includes a stop rod fixedly connected to a side wall of the housing, a sensing spring fixedly connected to a bottom of the stop rod, a retractable rod fixedly connected to a bottom of the sensing spring, and a sensing block fixedly connected to a bottom of the retractable rod;
one end of the wedge rotating rod is fixedly connected to the wedge rotating shaft, and the other end is connected to the electromagnetic transmission rod through the wedge connecting rod; and
the electromagnetic transmission rod is connected to the fork rod through the rod connecting shaft to constitute a folding transmission mechanism.

As a preferred solution of the irreversible passive gripping apparatus of the present invention, the wedge has a gripping tolerance of at least 1 mm for the edge of the gripped object; and the housing has a single gripper arm with a cross section of 50×50 mm, a breaking load larger than or equal to 8,000 kg, and an elasticity limit larger than or equal to 4,000 kg.

As a preferred solution of the irreversible passive gripping apparatus of the present invention, a gripping process of the wedge does not require a work of the transmission mechanism, and the wedge rotating shaft limit the wedge, making the wedge not physically rotate downward to loosen goods; and
the control assembly is remotely controlled by an operator in a nuclear facility control room, and the sensing assembly is used for feeding a working state of the gripping apparatus back to the control room, detecting a grasping state, and sending a signal to the operator.

In order to solve the above technical problems, the present invention provides the following technical solution: an irreversible passive gripping method includes: an irreversible passive gripping apparatus; and
moving the irreversible passive gripping apparatus to a position above a to-be-gripped gripped object, and aligning the irreversible passive gripping apparatus to the gripped object through a control assembly;
achieving passive gripping by forming mechanical interference between a wedged structure in a clamping assembly and the edge of the gripped object;
executing corresponding operations (including, but not limited to lifting, handling, stacking, nesting and other procedures) according to different working conditions; and
executing a releasing action through the control assembly after confirmation of stable support to the gripped object.

As a preferred solution of the irreversible passive gripping method for an American radioactive bucket by IPGS-AT of the present invention, the moving the irreversible passive gripping apparatus to a position above a to-be-gripped gripped object, and aligning the irreversible passive gripping apparatus to the gripped object through the control assembly includes:
checking a working state of a sensing assembly;
confirming that a wedge gripping tolerance is larger than and equal to 1 mm;
verifying a calibration state of release force of an electromagnetic transmission rod; and
selecting an appropriate gripping position, selecting an upper edge curl for an opened bucket, and selecting a bottom of a sealing ring for a sealed bucket; and

the achieving passive gripping by forming mechanical interference between a wedged structure in a clamping assembly and the edge of the gripped object includes:
making a wedge automatically folded by using own driving force of the gripped object;
forming mechanical interference between the wedged structure and the gripped object; and
ensuring the wedge to carry a weight of the gripped object, independent of a transmission system.

The present invention has the beneficial effects that: by arranging a gripping unit, the present invention adopts the geometric shape of the wedge to form a mechanical interference fit to the radioactive bucket to achieve passive gripping and automatic locking; and the gripping state can be maintained without additional energy input, thereby avoiding a risk of accidental falling of the radioactive bucket due to a power supply or control system failure. The transmission assembly is only used for a release process and requires active control of the operator, so as to prevent a risk of radioactive leakage in a case of misoperation or by an accident. A wedged design of the wedge makes it unable to be folded and make a release in a carrying state, and has tolerance adaptability to the edge of the bucket at the same time, which not only ensures reliability of gripping, but also expands a scope of application. The sensing assembly monitors the gripping state in real time and feeds it back to the control room, so that the operator can know a working condition of the apparatus in time, thereby improving safety of a remote operation. A passive gripping mechanism of the present invention greatly simplifies an operation process, shortens the gripping time, ensures safety through inherent characteristics of a mechanical structure at the same time, avoids a potential danger during radioactive material treatment, and improves operation efficiency and safety of a radioactive waste storage facility. In addition, by adopting a reasonable structural size and material in the design of the gripper arm, the present invention enables a single gripper arm to have the breaking load of up to 8,000 kg and the elasticity limit of 4,000 kg, thereby ensuring safety and reliability under a heavy load condition.

### BRIEF DESCRIPTION OF DRAWINGS

To more clearly illustrate the technical solutions of the embodiments of the present invention, the following is a brief introduction to the drawings required for the description of the embodiments. Obviously, the drawings described below are only some embodiments of the present invention. For those of ordinary skill in the art, other drawings can be obtained based on these drawings without creative labor. In the drawings:

FIG. 1 is a schematic diagram of an overall structure of an irreversible passive gripping apparatus;

FIG. 2 is a cross-section diagram of an overall structure of an irreversible passive gripping apparatus;

FIG. 3 is a partial cross-section view of an irreversible passive gripping apparatus;

FIG. 4 is a cross-section view of a sensing assembly of an irreversible passive gripping apparatus; and

FIG. 5 is a flowchart of an irreversible passive gripping method.

### DETAILED DESCRIPTION OF THE EMBODIMENTS

To make the described objectives, features and advantages of the present invention more obvious and more understandable, the specific embodiments of the present invention are described in detail below in conjunction with the accompanying drawings.

A number of specific details are set forth in the description below to provide a thorough understanding for the present invention, however, the present invention may also be implemented in other manners different from those described herein, and those skilled in the art may make similar generalization without departing from the essence of the present invention; therefore, the present invention is not limited by the specific embodiments disclosed below.

Secondly, “one embodiment” or “embodiment” referred to herein refers to a specific feature, structure, or characteristic that may be included in at least one implementation manner of the present invention. The “in one embodiment” appearing in different parts of the present specification does not necessarily refer to the same embodiment, nor a separate or selective embodiment that is mutually exclusive to other embodiments.

### Embodiment 1

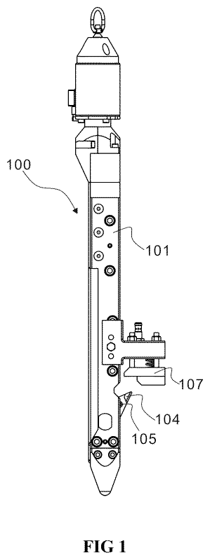

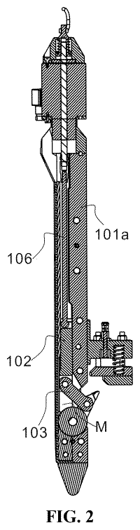

Referring to FIGS. 1-2, showing a first embodiment of the present invention, the embodiment provides an irreversible passive gripping apparatus 100, including a clamping assembly 104, which is in a gripping position in a default state and can be folded and make a release only in driving by a sliding assembly 102,
specifically, a fixed assembly 101, provided with an accommodating space M inside;
a sliding assembly 102, slidably arranged inside fixed assembly 101;
a connecting rod assembly 103, having one end rotatably connected to the sliding assembly 102; and
a clamping assembly 104, having one end rotatably connected to the fixed assembly 101, where one end, close to the clamping assembly 104, of the connecting rod assembly 103 is rotatably connected to the clamping assembly 104.

When the sliding assembly 102 slides toward the clamping assembly 104, the clamping assembly 104 rotates out of the interior of the accommodating space M to form a clamping angle; and
there are at least two groups of symmetric irreversible passive gripping apparatuses 100, and the clamping assembly 104 cannot be folded and make a release in carrying a gripped object due to its geometric shape.

To sum up, by arranging a gripping unit, the present invention adopts the geometric shape of the wedge to form a mechanical interference fit to the radioactive bucket to achieve passive gripping and automatic locking; and the gripping state can be maintained without additional energy input, thereby avoiding a risk of accidental falling of the radioactive bucket due to a power supply or control system failure. The transmission assembly is only used for a release process and requires active control of the operator, so as to prevent a risk of radioactive leakage in a case of misoperation or by an accident. A wedged design of the wedge makes it unable to be folded and make a release in a carrying state, and has tolerance adaptability to the edge of the bucket at the same time, which not only ensures reliability of gripping, but also expands a scope of application. The sensing assembly monitors the gripping state in real time and feeds it back to the control room, so that the operator can know a working condition of the apparatus in time, thereby improving safety of a remote operation. A passive gripping mechanism of the present invention greatly simplifies an operation process, shortens the gripping time, ensures safety through inherent characteristics of a mechanical structure at the same time, avoids a potential danger during radioactive material treatment, and improves operation efficiency and safety of a radioactive waste storage facility. In addition, by adopting a reasonable structural size and material in the design of the gripper arm, the present invention enables a single gripper arm to have the breaking load of up to 8,000 kg and the elasticity limit of 4,000 kg, thereby ensuring safety and reliability under a heavy load condition.

### Embodiment 2

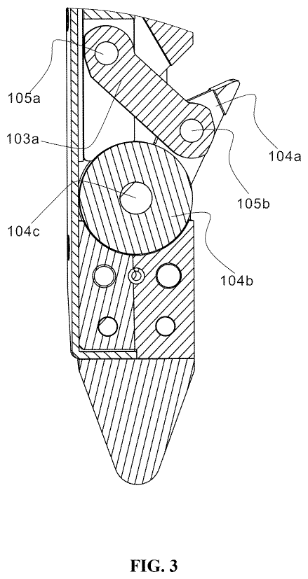

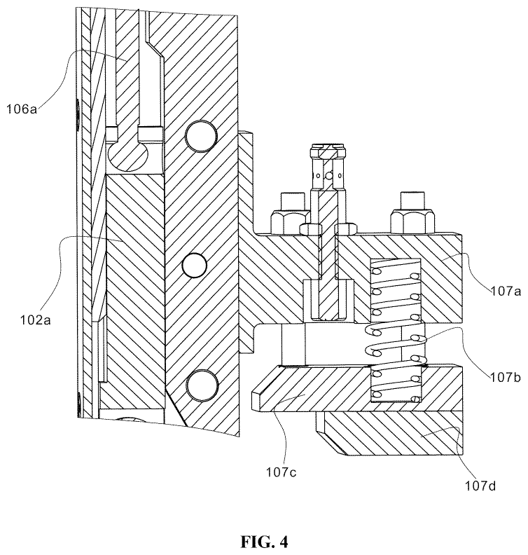

Referring to FIGS. 1-4, showing a second embodiment of the present invention, the embodiment provides an irreversible passive gripping apparatus, including a housing 101a as a supporting frame. A wedge 104a is installed on the housing 101a through a wedge rotating shaft 104b and connected to a wedge rotating rod 103a; an electromagnetic transmission rod 106a is driven by a rotating shaft 104c; a wedge connecting rod 105b is used for connecting the wedge rotating rod 103a with the electromagnetic transmission rod 106a; and a rod connecting shaft 105a and a fork rod 102a constitute a folding transmission mechanism. The wedge 104a is designed using a wedged structure, and can automatically form mechanical interference with an edge of a radioactive bucket to achieve passive gripping. The wedge 104a is in a gripping position in a default sate, and can be folded and make a release only in driving by the electromagnetic transmission rod 106a.
specifically, a fixed assembly 101, provided with an accommodating space M inside;
a sliding assembly 102, slidably arranged inside fixed assembly 101;
a connecting rod assembly 103, having one end rotatably connected to the sliding assembly 102; and
a clamping assembly 104, having one end rotatably connected to the fixed assembly 101, where one end, close to the clamping assembly 104, of the connecting rod assembly 103 is rotatably connected to the clamping assembly 104.

When the sliding assembly 102 slides toward the clamping assembly 104, the clamping assembly 104 rotates out of the interior of the accommodating space M to form a clamping angle; and
there are at least two groups of symmetric irreversible passive gripping apparatuses 100, and the clamping assembly 104 cannot be folded and make a release in carrying a gripped object due to its geometric shape.

Preferably, the embodiment adopts four groups of irreversible passive gripping apparatuses 100, so as to provide higher gripping stability and safety redundancy. Each of the four groups of irreversible passive gripping apparatuses 100 includes a fixed assembly 101, a sliding assembly 102, a connecting rod assembly 103, a clamping assembly 104, a transmission assembly 105, a control assembly 106, and a sensing assembly 107. It is to be noted that such a modular design facilitates maintenance and replacement while ensuring reliability of a system.

The irreversible passive gripping apparatuses further includes a transmission assembly 105.

The transmission assembly 105 includes a rod connecting shaft 105a connected to a side wall of the sliding assembly 102, and a wedge connecting rod 105b connected to one end, close to the clamping assembly 104, of the connecting rod assembly 103.

The fixed assembly 101 includes a housing 101a.

The sliding assembly 102 includes a fork rod 102a, and the fork rod 102a is slidably arranged inside the housing 101a.

The connecting rod assembly 103 includes a wedge rotating rod 103a, and two ends of the wedge rotating rod 103a are rotatably connected to the rod connecting shaft 105a and the wedge connecting rod 105b respectively.

The clamping assembly 104 includes a wedge 104a, a wedge rotating shaft 104b connected to one end of the wedge 104a, and a rotating shaft 104c connected to a middle part of the wedge rotating shaft 104b.

Further, the wedge 104a is automatically folded by driving force from an edge of the gripped object during gripping to achieve passive gripping, and the wedge 104a carries a weight of the gripped object through a mechanical interference structure, independent of a transmission system; and
the wedge 104a cannot be folded and make a release in carrying the gripped object due to its geometric shape.

Preferably, the wedge connecting rod 105b is made of high strength alloy steel to provide sufficient mechanical strength. A surface of the wedge 104a is specially hardened to improve its wear resistance. A wedge angle is designed between 30 degrees and 45 degrees, which can provide the best self-locking effect.

Further, the wedge 104a includes a wedged body, used for forming a mechanical interference fit to an edge of the gripped object; and
a geometric structure of the wedged body is designed for snapping under a curl of an edge of the gripped object or onto a bottom of a sealing ring.

Preferably, a contact surface of the wedged body adopts a special anti-skid texture design to increase friction.

The irreversible passive gripping apparatuses further includes a control assembly 106 and a sensing assembly 107, where the control assembly 106 includes an electromagnetic transmission rod 106a, and the electromagnetic transmission rod 106a is only used for folding and releasing actions of the wedge 104a without participating in gripping and load carrying; and
release force of the electromagnetic transmission rod 106a is calibrated to prevent a release apparatus from starting in a case of an incomplete release of a load.

Further, the sensing assembly 107 includes a stop rod 107a fixedly connected to a side wall of the housing 101a, a sensing spring 107b fixedly connected to a bottom of the stop rod 107a, a retractable rod 107c fixedly connected to a bottom of the sensing spring 107b, and a sensing block 107d fixedly connected to a bottom of the retractable rod 107c;
one end of the wedge rotating rod 103a is fixedly connected to the wedge rotating shaft 104b, and the other end is connected to the electromagnetic transmission rod 106a through the wedge connecting rod 105b; and
the electromagnetic transmission rod 106a is connected to the fork rod 102a through the rod connecting shaft 105a to constitute a folding transmission mechanism.

Further, the wedge 104 a has a gripping tolerance of at least 1 mm for the edge of the gripped object; and the housing 101 a has a single gripper arm with a cross section of 50 ×50 mm, a breaking load larger than or equal to 8,000 kg, and an elasticity limit larger than or equal to 4,000 kg.

A gripping process of the wedge 104a does not require a work of the transmission mechanism, and the wedge rotating shaft 104b limits the wedge 104a, making the wedge not physically rotate downward to loosen goods; and
further, the control assembly 106 is remotely controlled by an operator in a nuclear facility control room, and the sensing assembly 107 is used for feeding a working state of the gripping apparatus back to the control room, detecting a grasping state, and sending a signal to the operator.

It is to be noted that a stroke of the electromagnetic transmission rod 106a is precisely controlled to ensure reliability of the releasing action. The housing 101a is modularly designed to facilitate maintenance and replacement. The sensing spring 107b is made of a material with excellent fatigue resistance, to ensure stability of long-time use.

In use, one end of the wedge rotating rod 103a is fixedly connected to the wedge rotating shaft 104b, and the other end is connected to the electromagnetic transmission rod 106a through the wedge connecting rod 105b. A self-lubricating bearing is adopted at a connecting part to reduce maintenance requirements. The electromagnetic transmission rod 106a is connected to the fork rod 102a through the rod connecting shaft 105a to form an intact folding transmission mechanism. All moving components of the transmission mechanism are designed with dustproof sealing.

When the edge of the radioactive bucket makes a contact to the wedge 104a, its driving force causes the wedge to be folded automatically to achieve passive gripping. It is to be noted that such passive gripping mechanism does not depend on any power input, which improves the reliability of the system. The folding angle of the wedge 104a is limited within a preset range to avoid excessive deformation. The wedge 104a independently carries a weight of the radioactive bucket through a mechanical interference structure, and its geometric shape ensures that it cannot be folded and make a release in a loading state.

The electromagnetic transmission rod 106a is only responsible for the folding and releasing actions of the wedge 104a, without participating in a gripping and load carrying process. Its release force is precisely calibrated, which can prevent the a release apparatus from starting accidentally in a case of the incomplete release of the load. The gripping tolerance of the wedge 104a for the edge of the radioactive bucket is that a tolerance fit between a gripper and gripped goods is larger than or equal to 1 mm, which ensures reliable gripping. The housing 101 a has a single gripper arm with a cross section of 50×50 mm, a breaking load larger than or equal to 8,000 kg, and an elasticity limit larger than or equal to 4,000 kg.

The whole system makes remote operations in the nuclear facility control room through the control assembly 103, and the sensing assembly 107 monitors the gripping state in real time and feeds the signal back to the control room. The gripping process of the wedge 104a does not require the work of the transmission mechanism, and the wedge rotating shaft 104b physically limits the wedge 104a, ensuring no occurrence of goods loosening caused by downward rotation.

To sum up, by arranging a gripping unit, the present invention adopts the geometric shape of the wedge to form a mechanical interference fit to the radioactive bucket to achieve passive gripping and automatic locking; and the gripping state can be maintained without additional energy input, thereby avoiding a risk of accidental falling of the radioactive bucket due to a power supply or control system failure. The transmission assembly is only used for a release process and requires active control of the operator, so as to prevent a risk of radioactive leakage in a case of misoperation or by an accident. A wedged design of the wedge makes it unable to be folded and make a release in a carrying state, and has tolerance adaptability to the edge of the bucket at the same time, which not only ensures reliability of gripping, but also expands a scope of application. The sensing assembly monitors the gripping state in real time and feeds it back to the control room, so that the operator can know a working condition of the apparatus in time, thereby improving safety of a remote operation. A passive gripping mechanism of the present invention greatly simplifies an operation process, shortens the gripping time, ensures safety through inherent characteristics of a mechanical structure at the same time, avoids a potential danger during radioactive material treatment, and improves operation efficiency and safety of a radioactive waste storage facility. In addition, by adopting a reasonable structural size and material in the design of the gripper arm, the present invention enables a single gripper arm to have the breaking load of up to 8,000 kg and the elasticity limit of 4,000 kg, thereby ensuring safety and reliability under a heavy load condition.

### Embodiment 3

Referring to FIGS. 1-4, showing a third embodiment of the present invention, the embodiment provides a variety of application scenarios of an irreversible passive gripping apparatus in a radioactive waste storage facility.

In a typical low-to-medium radioactive waste storage facility, various sizes of buckets and containers are needed to be treated. First, for a standard American bucket body operation, the system can treat a radioactive bucket that meets the UNE-EN ISO 15750-1: 2008 standard, including removable-head buckets with minimum capacities being 208 L, 210 L, and 216.5 L. The system can select the gripping position according to a state of the bucket. For the opened bucket, the system can directly grip an upper edge curl. For the sealed barrel, the system can snap onto the bottom of the sealing ring for a sealed bucket. The wedged structure having the gripping tolerance of at least 1 mm ensures adaptability to different bucket bodies.

In a complicated storage environment, it is often necessary to treat nested buckets. The system can treat small bucket bodies nested in other buckets or containers. Through precise positioning of the wedge 104a and the remote operations of the control assembly 103, a target bucket can be accurately gripped within a narrow space. Gripping force of the system does not depend on a weight of the bucket, so even a lighter nested bucket body can be firmly gripped to avoid shaking or falling off during lifting.

For an operation of a large storage container, the system can transfer and rearrange the bucket body in the container. The housing has the single gripper arm with a cross section design of 50×50 mm, the breaking load of 8,000 kg and the elasticity limit of 4,000 kg, completely meeting the demand for a heavy load condition. The sensing assembly can monitor the gripping state in real time to ensure safe and controllable operations in the container.

In a bucket body stacking operation, the system can execute precise vertical lifting and placement actions. A passive gripping mechanism of the wedge 104a is automatically locked during lifting, and the calibrated release force of the electromagnetic transmission rod 106a ensures smooth placement of the bucket body. When it is necessary to place a stabilizing plate between the stacked layers, the system can also place the plate through precise control.

During a filling or sealing operation, the system can maintain stability of the bucket body, in cooperation with concrete sealing, filling gaps with gravel or other procedures. Because the system adopts the passive gripping mechanism, it can maintain stable clamping even in a vibration environment. The operator can remotely monitor the entire process through the nuclear facility control room, and the sensing assembly 107 can timely feed the operation state back to ensure the safety.

Another important application of the system is in a bucket body transfer process. When there is a need for transferring the bucket body from one workstation to another workstation, the system can achieve stable gripping throughout the process. A mechanical interference design of the wedge ensures no accidental release during movement. The control assembly 106 can start only under a conscious release operation, which effectively prevents a possible safety accident during transportation.

In daily maintenance and emergency cases, the system also shows unique advantages. Even in a case of power system failure, the passive gripping mechanism of the wedge 104a can still ensure safe suspension of the bucket body. A simple structure design of the system reduces the maintenance requirements and provides necessary emergency treatment capabilities at the same time. In a case of requiring a rapid response, the system can improve operation efficiency on the premise of ensuring safety.

To sum up, these application scenarios demonstrate versatility and adaptability of the system in treating radioactive wastes, which can meet the operation requirements under different working conditions, while always maintaining high safety and reliability. Through the remote operations and intelligent monitoring, the system can effectively reduce a radiation exposure risk of the operator and improve working efficiency.

### Embodiment 4

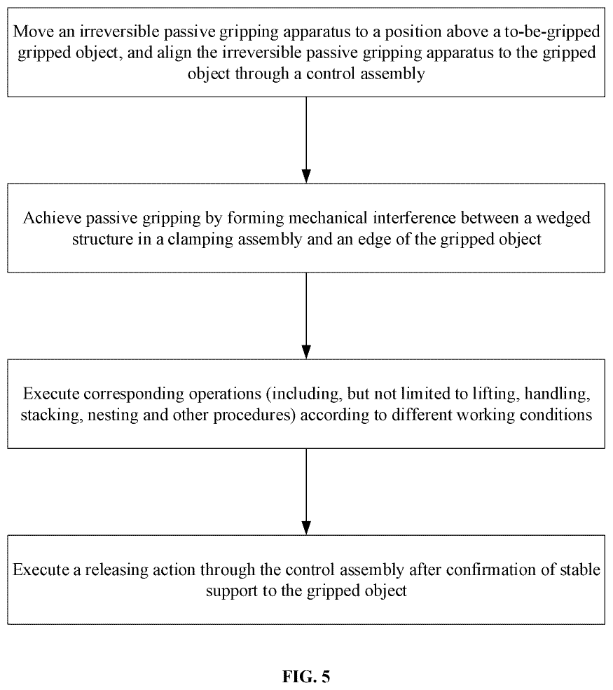

Referring to FIGS. 1-5, showing a fourth embodiment of the present invention, the embodiment provides an irreversible passive gripping method for an American radioactive bucket by IPGS-AT, including:
S1: moving the irreversible passive gripping apparatus to a position above a to-be-gripped gripped object, and aligning the irreversible passive gripping apparatus to a bucket body through a control assembly.

More further, the irreversible passive gripping apparatus 100 is controlled to move to a position above a to-be-gripped radioactive bucket, and a fork rod 102a of the sliding assembly 102, a rod connecting shaft 105a, and a wedge rotating rod 103a are cooperated to achieve precise positioning to ensure that the clamping assembly 104 can accurately align to a bucket body gripping position.

It is to be noted that a gripping and positioning process first needs to confirm an operation state of a control assembly 106, including a calibration state of an electromagnetic transmission rod 106a and structural integrity of a housing 101a, and then to select an appropriate gripping position according to a type of the bucket body: to aim at an upper edge curl for an opened bucket, and to align to a bottom of a sealing ring for a sealed bucket.

S2: achieving passive gripping by forming mechanical interference between a wedged structure in a clamping assembly and an edge of the gripped object.

More further, gripping execution includes driving the wedge to be automatically folded by means of a dead weight of the bucket body by using a contact of the wedge 104a in the clamping assembly 104 to the edge of the radioactive bucket; and achieving a complete passive gripping process by cooperation of a wedge rotating shaft 104b and a rotating shaft 104c to complete a clamping action.

It is to be noted that a wedged body structure design of the wedge 104a ensures that it can form a stable gripping state with the bucket body through pure mechanical interference without additional power input, and has a gripping tolerance of at least 1 mm, that is, tolerance adaptability between a gripper and gripped goods.

S3: executing corresponding operations (including, but not limited to lifting, handling, stacking, nesting and other procedures) according to different working conditions.

More further, executing corresponding operations according to different working conditions includes performing the following operations according to different needs:
standard lifting and handling: maintaining stable vertical lifting and horizontal movement;
bucket body stacking: ensuring accurate space positioning and smooth descending;
nesting treatment: completing a complicated space operation on the premise of ensuring precision; and
sealing with filling: maintaining a stable clamping state to cooperate with other procedures.

It is to be noted that all operations under various working conditions depend on characteristics of the wedge 104a independently carrying a weight of the radioactive bucket through a mechanical interference structure to ensure safety during operation. The housing 101a has a cross section of 50×50 mm and a breaking load design of 8,000 kg, providing sufficient structural assurance.

S4: executing a releasing action through the control assembly after confirmation of stable support to the gripped object.

More further, the release operation includes confirming that the radioactive bucket obtains stable support, checking a safety state of a surrounding environment, executing the releasing action through an the electromagnetic transmission rod 106a of the control assembly 106, and waiting for the sensing assembly 107 to feed back a release completion signal.

It is to be noted that the release process is controlled by the calibrated electromagnetic transmission rod 106a to ensure that the release mechanism will not accidentally start before the load is completely released, and the system will continuously monitor the entire release process until the release mechanism is completely separated at the same time.

Importantly, it should be noted that the constructions and arrangements of the present application shown in a plurality of different exemplary implementation solutions are merely exemplary. Although only a few implementation solutions are described in detail in the contents disclosed herein, those having reference to the contents disclosed herein should readily understand that many modifications are possible (for example, variations in the sizes, dimensions, structures, shapes and proportions of various elements, parameter values (such as temperatures and pressures), installations and arrangements, use of materials, colors, orientations, etc.), without materially departing from the novel teachings and advantages of the subject described in the present application. For example, the elements shown as integrally formed may be constructed of a plurality of parts or elements, the positions of the elements may be inverted or varied in other manners, and the properties, quantities or positions of the discrete elements may be altered or varied. Therefore, all such modifications are intended to be included within the scope of the present invention. The order or sequence of any process or method steps may be changed or re-sequenced according to alternative embodiments. In the claims, any provision of “apparatus with function” is intended to cover the structure described herein for executing the function, and is not merely structurally equivalent but also equivalent in structure. Other substitutions, modifications, variations, and omissions may be made in the design, operation conditions, and arrangements of the exemplary implementation solutions without departing from the scope of the present invention. Therefore, the present invention is not limited to the specific implementation solutions but extends to a plurality of modifications still falling within the scope of the appended claims.

In addition, in order to provide a concise description for the exemplary implementation solutions, not all features of an actual implementation solution are described (that is, those features that are not relevant to the currently-considered optimal mode for executing the present invention, or those features that are not relevant to realizing the present invention).

It should be appreciated that lots of decisions on specific embodiments can be made during any actual practical development, for example, in any engineering or design project. Such development efforts may be complicated and time-consuming, but for those skilled in the art benefiting from the present invention, too many experiments are not necessary, and the development efforts will be a regular work of design, making and production.

It should be noted that, the above embodiments are merely used for illustrating the technical solution of the present invention and not to limit the technical solution, although the present invention has been described in detail with reference to the preferred embodiments, those of ordinary skill in the art should understand that, modifications or equivalent substitutions may be made on the technical solution of the present invention without departing from the spirit and scope of the technical solution of the present invention, and the modifications or equivalent substitutions should be incorporated into the scope of the claims of the present invention.

What is claimed is:

1. An irreversible passive gripping apparatus, comprising:
a fixed assembly, provided with an accommodating space inside;
a sliding assembly, slidably arranged inside the fixed assembly;
a connecting rod assembly, having one end rotatably connected to the sliding assembly; and
a clamping assembly, having one end rotatably connected to the fixed assembly, one end, close to the clamping assembly, of the connecting rod assembly being rotatably connected to the clamping assembly, wherein
when the sliding assembly slides toward the clamping assembly, the clamping assembly rotates out of the interior of the accommodating space to form a clamping angle; and
there are at least two groups of symmetric irreversible passive gripping apparatuses, and the clamping assembly cannot be folded and make a release in carrying a gripped object due to a geometric shape of the clamping assembly.

2. The irreversible passive gripping apparatus according to claim 1, further comprising a transmission assembly;
the transmission assembly comprises a rod connecting shaft connected to a side wall of the sliding assembly, and a wedge connecting rod connected to one end, close to the clamping assembly, of the connecting rod assembly;
the fixed assembly comprises a housing;
the sliding assembly comprises a fork rod, and the fork rod is slidably arranged inside the housing;
the connecting rod assembly comprises a wedge rotating rod, and two ends of the wedge rotating rod are rotatably connected to the rod connecting shaft and the wedge connecting rod respectively; and
the clamping assembly comprises a wedge, a wedge rotating shaft connected to one end of the wedge, and a rotating shaft connected to a middle part of the wedge rotating shaft.

3. The irreversible passive gripping apparatus according to claim 2, wherein the wedge is automatically folded by driving force from an edge of the gripped object during gripping to achieve passive gripping, and the wedge carries a weight of the gripped object through a mechanical interference structure, independent of a transmission system; and
the wedge cannot be folded and make a release in carrying the gripped object due to a geometric shape of the wedge.

4. The irreversible passive gripping apparatus according to claim 3, wherein the wedge comprises a wedged body, used for forming a mechanical interference fit to an edge of the gripped object; and
a geometric structure of the wedged body is designed for snapping under a curl of an edge of the gripped object or onto a bottom of a sealing ring.

5. The irreversible passive gripping apparatus according to claim 4, further comprising a control assembly and a sensing assembly, wherein the control assembly comprises an electromagnetic transmission rod, and the electromagnetic transmission rod is only used for folding and releasing actions of the wedge without participating in gripping and load carrying; and
release force of the electromagnetic transmission rod is calibrated to prevent a release apparatus from starting in a case of an incomplete release of a load.

6. The irreversible passive gripping apparatus according to claim 5, wherein the sensing assembly comprises a stop rod fixedly connected to a side wall of the housing, a sensing spring fixedly connected to a bottom of the stop rod, a retractable rod fixedly connected to a bottom of the sensing spring, and a sensing block fixedly connected to a bottom of the retractable rod;
one end of the wedge rotating rod is fixedly connected to the wedge rotating shaft, and the other end is connected to the electromagnetic transmission rod through the wedge connecting rod; and
the electromagnetic transmission rod is connected to the fork rod through the rod connecting shaft to constitute a folding transmission mechanism.

7. The irreversible passive gripping apparatus according to claim 6, wherein the wedge has a gripping tolerance of at least 1 mm for the edge of the gripped object; and the housing has a single gripper arm with a cross section of 50×50 mm, a breaking load larger than or equal to 8,000 kg, and an elasticity limit larger than or equal to 4,000 kg.

8. The irreversible passive gripping apparatus according to claim 7, wherein a gripping process of the wedge does not require a work of the transmission mechanism, and the wedge rotating shaft limits the wedge, making the wedge not physically rotate downward to loosen goods; and
the control assembly is remotely controlled by an operator in a nuclear facility control room, and the sensing assembly is used for feeding a working state of the gripping apparatus back to the control room, detecting a grasping state, and sending a signal to the operator.

9. An irreversible passive gripping method, comprising: the irreversible passive gripping apparatus according to claim 1; and
moving the irreversible passive gripping apparatus to a position above a to-be-gripped gripped object, and aligning the irreversible passive gripping apparatus to the gripped object through a control assembly;
achieving passive gripping by forming mechanical interference between a wedged structure in a clamping assembly and the edge of the gripped object;
executing corresponding operations (including, but not limited to lifting, handling, stacking, nesting and other procedures) according to different working conditions; and
executing a releasing action through the control assembly after confirmation of stable support to the gripped object.

10. The irreversible passive gripping method according to claim 9, wherein the moving the irreversible passive gripping apparatus to a position above a to-be-gripped gripped object, and aligning the irreversible passive gripping apparatus to the gripped object through the control assembly comprises:
checking a working state of a sensing assembly;
confirming that a wedge gripping tolerance is larger than and equal to 1 mm;
verifying a calibration state of release force of an electromagnetic transmission rod; and
selecting an appropriate gripping position, selecting an upper edge curl for an opened bucket, and selecting a bottom of a sealing ring for a sealed bucket; and
the achieving passive gripping by forming mechanical interference between a wedged structure in a clamping assembly and the edge of the gripped object comprises:
making a wedge automatically folded by using own driving force of the gripped object;
forming mechanical interference between the wedged structure and the gripped object; and
ensuring the wedge to carry a weight of the gripped object, independent of a transmission system.
